(19) United States
(12) Patent Application Publication
(10) Pub. No.: US 2004/0005797 A1
(43) Pub. Date: Jan. 8, 2004

(54) Two and three heads multi purpose plug

(76) Inventor: David Reyad Marks, Hayward, CA (US)

Correspondence Address: David Marks, P.o. Box 56168, San Jose, CA, 95156-6168, US

(21) Appl. No.: 10/131,060

(22) Filed: Jul. 8, 2002

(51) Int. Cl. H01R 13/648

(52) U.S. Cl. 439/104

(57) ABSTRACT

With this patent I'm Inventing a new pluging system in our houses.

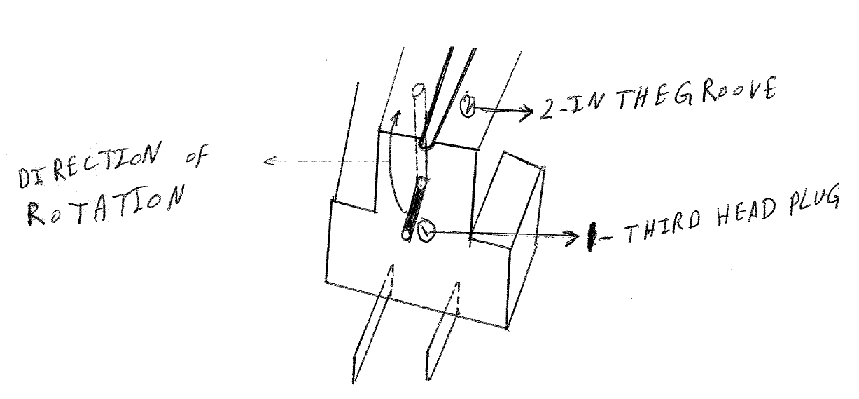

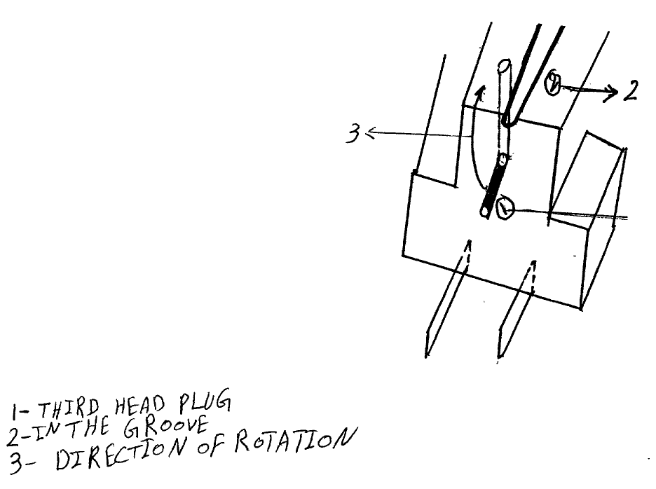

If we consider the regular plug which is either two heads or three heads as a regular plug then we should be looking at a plug with (the two and three heads at the same time). The regular plug has eiher two or three heads but if we make the third removable or retractable or compressed head then we are looking at the new product. The removable head can be made in the form of a screw or a retractable head as the nail clipper knife or compressed spring head to get into the third hole for the three heads power source or compressed in case of two holes power source. This product can come as an adaptor or in the shape of a wire with a two or three heads plug to be used in any connection device as the one at the back of a Computer, Printer, Cassete, Tv, Vcr, Dvd, Laptop, or a vaccuum or any other electric device and the multi connection plug, and can come with a telephone jack with the adaptor or any electric device that needs the phone jack as the computer.

This invention is as follows.

If we consider the regular plug which is either two heads or three heads as a regular plug then we should be looking at a plug with (the two and three heads at the same time).

The regular plug has two heads but if we add a removable head then we are looking at the new product. The removable head can be made in the form of a screw or a retractable head as the nail clipper knife. This product can come as an adaptor or in the shape of a wire with a two or three heads plug to be used in any connection device as the one at the back of a Computer, Printer, Cassete, Tv, Vcr, Dvd, Laptop, or a vaccuum or any other electric device and the multi connection plug, and can come with a telephone jack with the adaptor or any electric device that needs the phone jack as the computer.

What I claim as my invention is:

1. My plug will be used instead of the two and three heads plugs, and the third head can be put either in a groove or made as a spring, and if it is made as a spring it will be compressed in case of two holes power source and extend and get in the rhird hole in case of three holes power source.
